(19) United States
(12) Patent Application Publication
(10) Pub. No.: US 2014/0158213 A1
(43) Pub. Date: Jun. 12, 2014

(54) ANTIFOULING STRUCTURE AND OPERATION METHOD OF SAME

(71) Applicants: Kentaro Usui, Osaka-shi (JP); Yusuke Waki, Osaka-shi (JP); Tomoko Teranishi, Osaka-shi (JP); Yuichi Iyama, Osaka-shi (JP)

(72) Inventors: Kentaro Usui, Osaka-shi (JP); Yusuke Waki, Osaka-shi (JP); Tomoko Teranishi, Osaka-shi (JP); Yuichi Iyama, Osaka-shi (JP)

(73) Assignee: SHARP KABUSHIKI KAISHA, Osaka-shi, Osaka (JP)

(21) Appl. No.: 14/233,482

(22) PCT Filed: Jul. 4, 2012
(86) PCT No.: PCT/JP2012/067091

§ 371 Date: Jan. 17, 2014

(30) Foreign Application Priority Data
Jul. 28, 2011 (JP) 2011-165641

(51) Int. Cl. B08B 15/00

(52) U.S. Cl. CPC B08B 15/00
USPC 137/13; 137/803

(57) ABSTRACT

Provided is an antifouling structure (4) for removing fouling on a surface (1a) of a solar cell (object) (1). The antifouling structure (4) includes a first electrode (5) and a second electrode (6) provided on the surface (1a) of the solar cell (1); a power supply (8) for applying voltage to the first electrode and the second electrode (5, 6); and a water-repellent dielectric layer (7) provided so as to cover at least one of the first electrode and the second electrode (5, 6). Voltage is applied to the first electrode and the second electrode (5, 6) from the power supply (8) such that an angle at which water (polar liquid) (10) present on the water-repellent dielectric layer (7) contacts the water-repellent dielectric layer decreases.

### TECHNICAL FIELD

The present invention relates to an antifouling structure for removing fouling on a surface of a construction (object) exposed to the outside, and an operation method of the antifouling structure.

### BACKGROUND ART

In recent years, antifouling structures are applied to outside-exposed surfaces of objects such as outdoor equipment, e.g., solar cells, outdoor constructions, e.g., houses, and vehicles driven outdoors, e.g., automobiles, in order to remove fouling, such as contaminants, e.g., dust, adhered onto the outside-exposed surfaces.

To be more specific, as a first conventional antifouling structure, Patent Document 1, for example, proposes attaching to a surface of a solar cell as the object a surface antifouling composite resin film having the capability of resisting contamination due to its surface hydrophilicity. That is, the first conventional antifouling structure utilizes, as a base film, a resin film having a thickness of at least 1 μm or more and, as the outermost layer, a dry coating film containing a silicone compound condensation product as a binder component and having a surface water droplet contact angle of 40° or less. Thus, according to the first conventional antifouling structure, fouling is less likely to adhere onto the outermost layer due to the outmost layer's above-mentioned hydrophilicity, and even if fouling is adhered, it can be washed off easily with rain water or the like.

Further, as a second conventional antifouling structure, Patent Document 2, for example, proposes attaching to a surface of a solar cell as the object a surface protection film including a base film and a water/oil-repellent antifouling layer provided on the base film. According to the second conventional antifouling structure, the antifouling layer prevents fouling from adhering onto the surface of the solar cell, and adhered/accumulated fouling, such as aqueous or oily dust in air, can readily be washed off with rain or the like and be removed.

### PRIOR ART DOCUMENTS

### Patent Documents

Patent Document 1: JP 2004-142161 A
Patent Document 2: JP 2002-83989 A

### DISCLOSURE OF INVENTION

### Problem to be Solved by the Invention

However, the problem with the above-mentioned conventional antifouling structures is that their capabilities of preventing fouling of a surface of a solar cell (object) deteriorate.

To be more specific, for the first conventional antifouling structure, since the outermost layer is hydrophilic, the layer may attract fouling depending on the composition and components of the fouling, and fouling with a strong polarity in particular tends to bond to the outermost layer. Further, when fouling is bonded to the outermost layer in such a manner, the surface will be covered with the fouling, leading to significant deterioration of the antifouling capability.

Further, the second conventional antifouling structure as described above includes a water-repellent antifouling layer. Once water droplets adhere onto the surface and evaporate or dry up, calcium chloride components contained in the droplets may remain on the surface and become noticeable as fouling or cause significant deterioration of the antifouling capability.

Furthermore, according to the second conventional antifouling structure, the water-repellent coating of the antifouling layer has a high surface resistance and is likely to get electrically charged in comparison with the first conventional antifouling structure with the hydrophilic surface. Hence, when the surface of the second conventional antifouling structure is electrically charged, the surface tends to attract fouling due to the charge, thereby causing deterioration of the antifouling capability.

With the foregoing in mind, it is an object of the present invention to provide an antifouling structure whose capability of preventing fouling of a surface of an object can avoid deterioration and an operation method of the antifouling structure.

### Means for Solving Problem

In order to achieve the above object, the antifouling structure according to the present invention is an antifouling structure for removing fouling on a surface of an object. The antifouling structure includes: a first electrode and a second electrode provided on the surface of the object; a power supply for applying voltage to the first electrode and the second electrode; and a water-repellent dielectric layer provided so as to cover at least one of the first electrode and the second electrode. Voltage is applied to the first electrode and the second electrode from the power supply such that an angle at which a polar liquid present on the water-repellent dielectric layer contacts the water-repellent dielectric layer decreases.

According to the antifouling structure configured as above, the first electrode and the second electrode are provided on the surface of the object, and the water-repellent dielectric layer is provided so as to cover at least one of the first electrode and the second electrode. Further, according to the antifouling structure, voltage is applied to the first electrode and the second electrode from the power supply such that the angle at which the polar liquid present on the water-repellent dielectric layer contacts the water-repellent dielectric layer decreases. Consequently, the water-repellent dielectric layer is made relatively hydrophilic due to the electrowetting phenomenon, thereby increasing the wettability of the polar liquid with respect to the water-repellent dielectric layer. As a result, fouling on the surface of the object can be removed with the polar liquid. Further, unlike the above-described conventional examples, the antifouling structure of the present invention can make the water-repellent dielectric layer serving as the (exposed) surface of the object hydrophilic. That is, unlike the above-described conventional examples, the antifouling structure of the present invention can actively change the condition of the surface from water-repellent to hydrophilic as appropriate with respect to fouling on the surface, so that its capability of preventing fouling of a surface of an object can avoid deterioration.

Further, in the above antifouling structure, it is preferable that a comb-shaped electrode having a plurality of electrode portions arranged in parallel to each other is used as at least one of the first electrode and the second electrode.

In this case, voltage can be applied to the polar liquid present on the water-repellent dielectric layer with certainty, and the capability of preventing fouling of the surface of the object can avoid deterioration with certainty.

Further, in the above antifouling structure, metal provided on the object surface side may be used as one of the first electrode and the second electrode.

In this case, the antifouling structure can be readily applied to a preinstalled object, and the antifouling structure having a simple structure can be formed using a small number of items with ease.

Further, the above antifouling structure may further include a dielectric layer having a higher dielectric constant than that of the water-repellent dielectric layer, the dielectric layer being provided so as to cover at least one of the first electrode and the second electrode on the object surface side of the water-repellent dielectric layer.

In this case, voltage can be applied to the polar liquid present on the water-repellent dielectric layer more effectively, so that it is possible to cause a change (decline) in the contact angle of the polar liquid due to the electrowetting phenomenon more efficiently. Thus, fouling on the surface of the object can be removed more efficiently.

In the above antifouling structure, it is preferable that the water-repellent dielectric layer is configured such that when no voltage is applied to the first electrode and the second electrode from the power supply, the angle at which the polar liquid present on the water-repellent dielectric layer contacts the water-repellent dielectric layer is within a range of 80° to 180°.

In this case, the surface energy on the water-repellent dielectric layer serving as the exposed surface of the object is reduced, so that the adhesion of fouling onto the exposed surface can be suppressed with ease.

Further, in the above antifouling structure, it is preferable that when voltage is applied to the first electrode and the second electrode from the power supply, the angle at which the polar liquid present on the water-repellent dielectric layer contacts the water-repellent dielectric layer is less than 80°.

In this case, the wettability of the polar liquid with respect to the water-repellent dielectric layer can be made more appropriate, so that fouling on the surface of the object can be removed with the polar liquid with certainty.

Further, the above antifouling structure may include: a switch connected between the power supply and one of the first electrode and the second electrode; a timer for measuring time; and an operation instruction portion for instructing switching of the switch, and the operation instruction portion may instruct switching of the switch based on timed results from the timer.

In this case, the antifouling structure can be operated automatically using timed results from the timer, so that fouling on the surface of the object can be removed with more certainty.

Further, the above antifouling structure may include: a switch connected between the power supply and one of the first electrode and the second electrode; and an operation instruction portion for instructing switching of the switch, and the operating instruction portion may instruct switching of the switch using an external input instruction signal from an outside source.

In this case, the antifouling structure can be operated automatically using an external input signal from an external device or apparatus such as a sensor, and fouling on the surface of the object can be removed with more certainty at appropriate timing.

Further, the above antifouling structure may include a timer for measuring time, and the operation instruction portion may instruct switching of the switch based on timed results from the timer.

In this case, the antifouling structure can be operated automatically using timed results from the timer in addition to the external input signal, and fouling on the surface of the object can be removed with more certainty at more appropriate timing.

Further, the operation method of the antifouling structure of the present invention is a method of operating an antifouling structure for removing fouling on a surface of an object, the antifouling structure including a first electrode and a second electrode provided on the surface of the object and a water-repellent dielectric layer provided so as to cover at least one of the first electrode and the second electrode. The method includes the steps of applying voltage to the first electrode and the second electrode such that an angle at which a polar liquid present on the water-repellent dielectric layer contacts the water-repellent dielectric layer decreases; and removing fouling on the object with the polar liquid.

According to the operation method of the antifouling structure configured as above, the water-repellent dielectric layer is made relatively hydrophilic due to the electrowetting phenomenon by carrying out the voltage application step, thereby increasing the wettability of the polar liquid with respect to the water-repellent dielectric layer. And fouling on the surface of the object can be removed with the polar liquid by carrying out the fouling removal step. That is, unlike the above-described conventional examples, the condition of the surface can be actively changed from water-repellent to hydrophilic as appropriate with respect to fouling on the surface, so that the capability of preventing fouling of the surface of the object can avoid deterioration.

### Effects of the Invention

According to the present invention, it is possible to provide an antifouling structure whose capability of preventing fouling of a surface of an object can avoid deterioration and an operation method of the antifouling structure.

### BRIEF DESCRIPTION OF DRAWINGS

FIG. 1 is a diagram for explaining a solar cell that uses an antifouling structure according to Embodiment 1 of the present invention.

FIG. 2 is a cross-sectional view showing the major configuration of the antifouling structure shown in FIG. 1.

FIG. 3 is a plan view for explaining the first electrode and the second electrode shown in FIG. 2.

FIG. 4A is a diagram for explaining the condition of water present on the water-repellent dielectric layer shown in FIG. 2 when no voltage is applied to the first electrode and the second electrode, and FIG. 4B is a diagram for explaining the condition of water present on the water-repellent dielectric layer when voltage is applied to the first electrode and the second electrode.

FIG. 5 is a block diagram showing a configuration of a controller for an antifouling structure according to Embodiment 2 of the present invention.

FIG. 6 is a cross-sectional view showing the major configuration of an antifouling structure according to Embodiment 3 of the present invention.

FIG. 7 is a plan view for explaining the first electrode and the second electrode shown in FIG. 6.

FIG. 8 is a block diagram showing a configuration of a controller for the antifouling structure shown in FIG. 6.

FIG. 9A is a diagram for explaining the condition of water present on the water-repellent dielectric layer shown in FIG. 6 when no voltage is applied to the first electrode and the second electrode shown in FIG. 6, and FIG. 9B is a diagram for explaining the condition of water present on the water-repellent dielectric layer shown in FIG. 6 when voltage is applied to the first electrode and the second electrode shown in FIG. 6.

FIG. 10 is a cross-sectional view showing the major configuration of an antifouling structure according to Embodiment 4 of the present invention.

FIG. 11 is a block diagram showing a configuration of a controller for the antifouling structure shown in FIG. 10.

FIG. 12 is a cross-sectional view showing the major configuration of an antifouling structure according to Embodiment 5 of the present invention.

FIG. 13 is a block diagram showing a configuration of a controller for the antifouling structure shown in FIG. 12.

FIG. 14A is a diagram for explaining the condition of water present on the water-repellent dielectric layer shown in FIG. 12 when no voltage is applied to the first electrode and the second electrode shown in FIG. 12, and FIG. 14B is a diagram for explaining the condition of water present on the water-repellent dielectric layer shown in FIG. 12 when voltage is applied to the first electrode and the second electrode shown in FIG. 12.

### DESCRIPTION OF THE INVENTION

Hereinafter, preferred embodiments of the antifouling structure and the operation method of the antifouling structure of the present invention will be described with reference to the drawings. In the following description, the antifouling structure of the present invention is applied to a solar cell or a body of an automobile (vehicle) as an example. Further, the size and size ratio of each of the constituent members in the drawings do not exactly reflect those of the actual constituent members.

### Embodiment 1

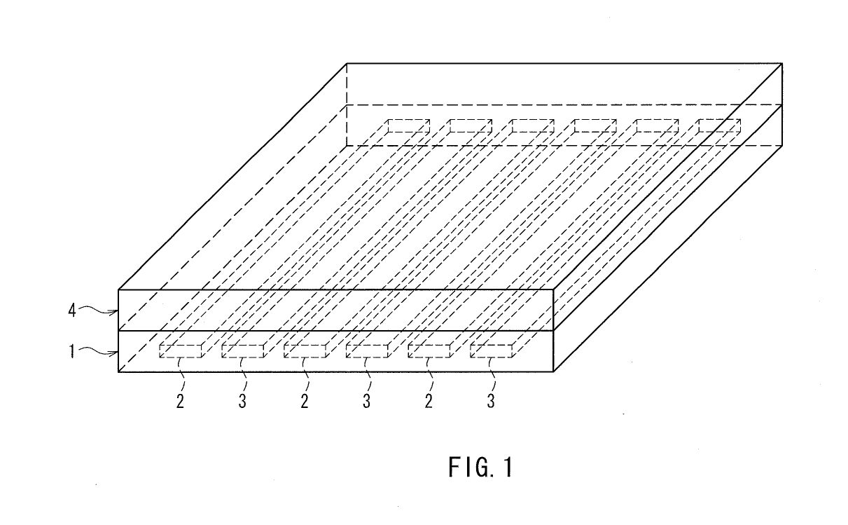

FIG. 1 is a diagram for explaining a solar cell that uses an antifouling structure according to Embodiment 1 of the present invention. In FIG. 1, a solar cell 1 includes an antifouling structure 4 of the present embodiment on the light-receiving surface side. Further, the solar cell 1 includes a strip-shaped electrode 2 as the positive electrode and a strip-shaped electrode 3 as the negative electrode, and the electrode 2 and the electrode 3 are arranged in alternate order. The solar cell 1 receives light that has passed through the antifouling structure 4, and power can be taken from the electrodes 2 and 3. Further, as will be described later in detail, the antifouling structure 4 has optical transparency, and it is provided so as to cover the entire light-receiving surface of the solar cell 1.

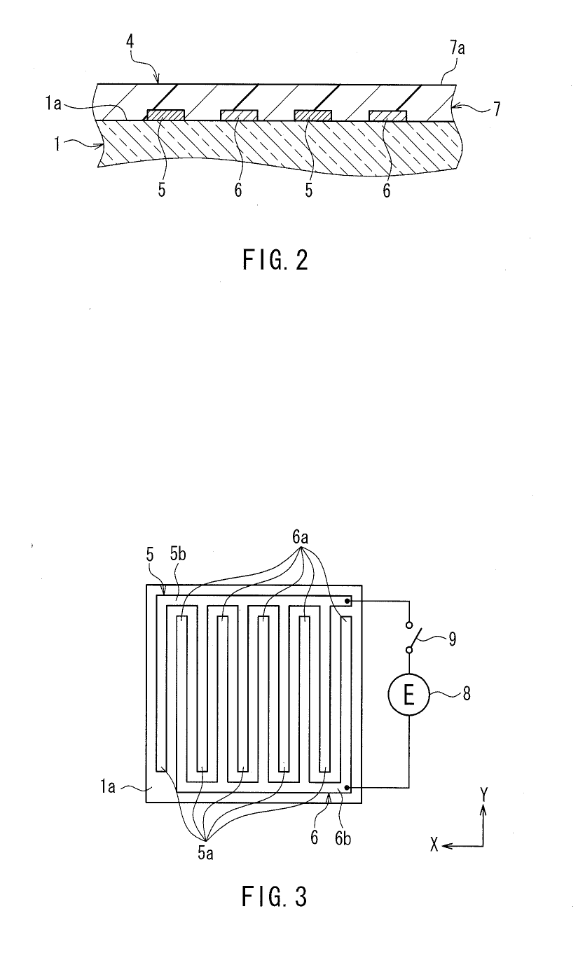

Next, the antifouling structure 4 of the present embodiment will be described more specifically with reference to FIGS. 2 and 3.

FIG. 2 is a cross-sectional view showing the main configuration of the antifouling structure shown in FIG. 1. FIG. 3 is a plan view for explaining a first electrode and a second electrode shown in FIG. 2.

As shown in FIG. 2, the antifouling structure 4 of the present embodiment includes a first electrode 5 and a second electrode 6 provided on a surface 1a of the solar cell 1 (object) and a water-repellent dielectric layer 7 provided so as to cover the first electrode 5 and the second electrode 6. Further, as described above, the antifouling structure 4 is provided so as to cover the entire light-receiving surface of the solar cell 1, and a surface 7a of the water-repellent dielectric layer 7 serves as the exposed surface of the solar cell 1 (object) exposed to the outside.

A transparent conductive film such as ITO or IZO is used as each of the first electrode 5 and the second electrode 6. Further, since a transparent dielectric film, such as a transparent organic film, e.g., a synthetic resin such as fluororesin, or a transparent inorganic film, is used as the water-repellent dielectric layer 7, a decline in the light receiving rate, and, by extension, in the power generation rate (power generation efficiency) of the solar cell 1 can be prevented as much as possible.

Further, as shown in FIG. 3, a comb-shaped electrode having a plurality of electrode portions 5a arranged in parallel to each other and a comb-shaped electrode having a plurality of electrode portion 6a arranged in parallel to each other are used as the first electrode 5 and the second electrode 6, respectively. That is, the first electrode 5 includes a plurality of, for example, five electrode portions 5a arranged in parallel to the Y direction and an electrode portion 5b arranged in parallel to the X direction and connected to one end of each of the five electrode portions 5a. Similarly, the second electrode 6 includes a plurality of, for example, five electrode portions 6a arranged in parallel to the Y direction and an electrode portion 6b arranged in parallel to the X direction and connected to one end of each of the five electrode portions 6a. Further, as shown in FIG. 3, the electrode portions 5a of the first electrode 5 and the electrode portions 6a of the second electrode 6 are arranged in alternate order.

Further, a power supply 8 is connected to the first electrode 5 and the second electrode 6 through a manual switch 9. Thus, according to the antifouling structure 4 of the present embodiment, voltage is applied to the first electrode 5 and the second electrode 6 from the power supply 8 when the manual switch 9 is switched from off to on. Further, according to the antifouling structure 4 of the present embodiment, voltage is applied to the first electrode 5 and the second electrode 6 from the power supply 8 such that the angle at which a polar liquid (water) (described later) on the water-repellent dielectric layer 7 contacts the water-repellent dielectric layer 7 decreases.

To be more specific, the water-repellent dielectric layer 7 is configured such that when no voltage is applied to the first electrode 5 and the second electrode 6 from the power supply 8 the angle at which water (polar liquid) present on the surface 7a of the water-repellent dielectric layer 7 contacts the water-repellent dielectric layer 7 is within a range of 80° to 180°, preferably 90° to 180°. And according to the antifouling structure 4 of the present embodiment, the angle at which the water present on the water-repellent dielectric layer 7 contacts the water-repellent dielectric layer 7 is less than 80°, preferably less than 60° when voltage is applied to the first electrode 5 and the second electrode 6 from the power supply 8. That is, according to the antifouling structure 4 of the present embodiment, the surface 7a of the water-repellent dielectric layer 7 becomes hydrophilic due to the electrowetting phenomenon when voltage is applied to the electrodes, thereby removing fouling on the surface 7a (i.e., fouling on the surface 1a of the solar cell 1) (described later in detail).

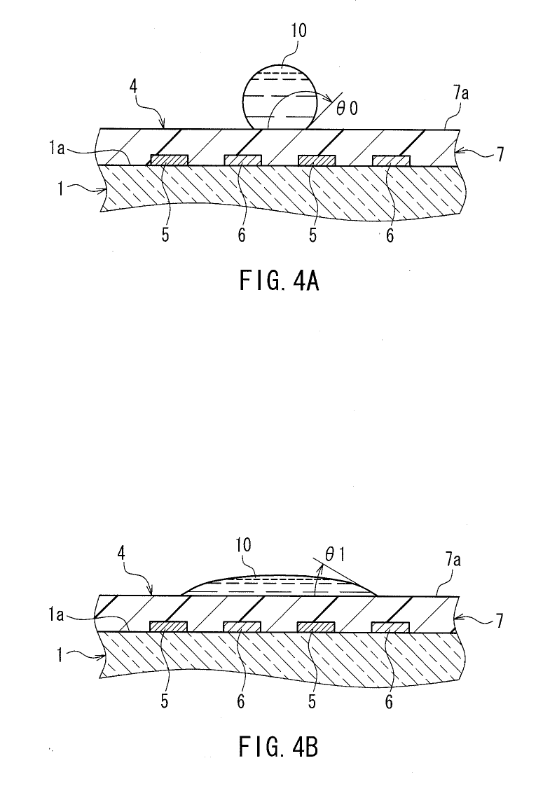

Here, the operation of the antifouling structure 4 of the present embodiment will be described more specifically with reference to FIGS. 4A and 4B.

FIG. 4A is a diagram for explaining the condition of water present on the water-repellent dielectric layer shown in FIG. 2 when no voltage is applied to the first electrode and the second electrode, and FIG. 4B is a diagram for explaining the condition of water present on the water-repellent dielectric layer when voltage is applied to the first electrode and the second electrode.

In FIG. 4A, water 10 is adhered onto the surface 7a of the water-repellent dielectric layer 7 due to rainfall, condensation, or the like. Further, in FIG. 4A, the electrowetting phenomenon is not developed because no voltage is applied to the first electrode 5 and the second electrode 6. Thus, the contact angle θ0 of the water 10 with respect to the water-repellent dielectric layer 7 is within a range of 80° to 180°, preferably 90° to 180°. That is, as shown in FIG. 4A, the wettability of the water 10 with respect to the water-repellent dielectric layer 7 is small, so that the water 10 is on the surface 7a of the water-repellent dielectric layer 7 substantially in spherical shape.

Next, when voltage is applied to the first electrode 5 and the second electrode 6 of the antifouling structure 4 of the present embodiment, the contact angle θ1 of the water 10 with respect to the water-repellent dielectric layer 7 becomes smaller than the contact angle θ0 as shown in FIG. 4B. Specifically, the contact angle θ1 becomes less than 80°, preferably less than 60°. That is, when voltage is applied to the first electrode 5 and the second electrode 6 of the antifouling structure 4 of the present embodiment, charge is accumulated inside the water-repellent dielectric layer 7 and the electrowetting phenomenon thus develops, thereby making the water-repellent dielectric layer 7 relatively hydrophilic. As a result, according to the antifouling structure 4 of the present embodiment, the wettability of the water 10 with respect to the water-repellent dielectric layer 7 increases, and the contact angle changes to θ1, the angle smaller than θ0. Thus, the water 10 spreads as shown in the figure.

That is, according to the antifouling structure 4 of the present embodiment, a voltage application step is carried out in such a manner that voltage is applied to the first electrode 5 and the second electrode 6 such that the angle at which the water (polar liquid) present on the water-repellent dielectric layer 7 contacts the water-repellent dielectric layer 7 decreases.

Then, according to the antifouling structure 4 of the present embodiment, the water 10 spread on the water-repellent dielectric layer 7 flows on the surface 7a of the water-repellent dielectric layer 7, and removes fouling, e.g., contaminants such as dust, adhered onto the surface 7a. That is, according to the antifouling structure 4 of the present embodiment, a fouling removal step is carried out following the voltage application step so as to remove fouling on the solar cell (object) 1 with the water 10 (polar liquid).

Here, before and after the application of voltage, i.e., before and after the development of the electrowetting phenomenon, the Lippmann Young equation shown below as (1) stands.

Y_{LG} cos θ1=Y_{LG} cos θ0+½CV² (1)

In the equation (1), Y_{LG} is surface (interface) energy between the water (polar liquid) 10 and air, C is the electrostatic capacity of the water-repellent dielectric layer 7, V is voltage applied to the first electrode 5 and the second electrode 6. As is clear from the equation (1), according to the antifouling structure 4 of the present embodiment, the contact angle of the water 10 on the water-repellent dielectric layer 7 can be reduced by application of voltage. That is, according to the antifouling structure 4 of the present embodiment, fouling on the water-repellent dielectric layer 7 can be removed with the water 10 by actively making the water-repellent dielectric layer 7 hydrophilic by application of voltage.

Further, since the surface energy Y_{LG} is constant, it is possible to adjust the degree of change in the contact angle θ1 by adjusting the electrostatic capacity C of the water-repellent dielectric layer 7 and the applied voltage V to the first electrode 5 and the second electrode 6.

Further, the water-repellent dielectric layer 7 has a thickness of, for example, 10 nm to 10 mm, preferably 10 nm to 100 μm. The smaller the thickness of the water-repellent dielectric layer 7, the degree of change in the contact angle due to the electrowetting phenomenon can be increased more. However, if the water-repellent dielectric layer 7 has a thickness of less than 10 nm, a breakdown is likely to occur in the water-repellent dielectric layer 7.

Further, either a DC supply or an AC supply may be used as the power supply 8. However, in terms of preventing the accumulation of undesired charge in the water-repellent dielectric layer 7, an AC supply that applies ac voltage is preferred. Further, the frequency to be used is preferably 1 kHz or less because it has little effect on a decline in dielectric constant of the water-repellent dielectric layer 7 due to dielectric dispersion. Moreover, the applied voltage V from the power supply 8 is, for example, 1V to 1000V, preferably 1V to 100V. That is, when the value of the applied voltage V is high, it is advantageous because the contact angle of the water 10 can be reduced more. However, the disadvantage is that it may cause a breakdown in the water-repellent dielectric layer 7 and lead to an increase in power consumption.

The electrode width (the size of each electrode portion 5a, 6a in the X direction and the size of each electrode portion 5b, 6b in the Y direction) of each of the first electrode 5 and the second electrode 6 is, for example, 1 μm to 1000 mm, preferably 1 μm to 100 mm. The larger the electrode width, more desirable it is for the object (water 10) with which the entire exposed surface (i.e., the surface 7a of the water-repellent dielectric layer 7) gets wet. However, in order to exert the effects of the electrowetting phenomenon on fine water droplets (water 10), it is desirable that the electrode width is small.

Furthermore, the spacing (clearance) between the electrode portions 5a, 5b of the first electrode 5 and the electrode portions 6a, 6b of the second electrode 6 is, for example, 1 μm to 100 mm, preferably 1 μm to 1 mm. The larger the spacing, undesired electrostatic capacity between the first electrode 5 and the second electrode 6 can be reduced more, allowing the electrowetting phenomenon to develop effectively. However, in order to exert the effects of the electrowetting phenomenon on fine water droplets (water 10), the spacing is desirably small. Further, a breakdown may occur when the spacing is smaller than 1 μm.

According to the antifouling structure 4 of the present embodiment configured as described above, the first electrode 5 and the second electrode 6 are provided on the surface 1a of the solar cell (object) 1, and the water-repellent dielectric layer 7 is provided so as to cover the first electrode 5 and the second electrode 6. Further, according to the antifouling structure 4 of the present embodiment, voltage is applied to the first electrode 5 and the second electrode 6 from the power supply 8 such that the angle at which the water (polar liquid) 10 present on the water-repellent dielectric layer 7 contacts the water-repellent dielectric layer 7 decreases. Consequently, according to the antifouling structure 4 of the present embodiment, since the wettability of the water 10 with respect to the water-repellent dielectric layer 7 is increased by making the water-repellent dielectric layer 7 relatively hydrophilic by the electrowetting phenomenon, fouling on the surface 7a of the water-repellent dielectric layer 7, i.e., the surface 1a of the solar cell 1 can be removed with the water 10. That is, unlike the above-described conventional examples, the antifouling structure 4 of the present embodiment can actively change the condition of the surface 7a from water-repellent to hydrophilic as appropriate with respect to fouling on the surface 7a of the water-repellent dielectric layer 7 (the surface 1a of the solar cell 1), so that the capability of preventing fouling of the surface 7a of the water-repellent dielectric layer 7 can avoid deterioration.

Further, according to the present embodiment, a comb-shaped electrode having a plurality of electrode portions 5a arranged in parallel to each other and a comb-shaped electrode having a plurality of electrode portions 6a arranged in parallel to each other are used as the first electrode 5 and the second electrode 6, respectively. Thus, it is possible to apply voltage to the water 10 present on the water-repellent dielectric layer 7 with certainty, and the capability of preventing fouling of the surface 7a of the water-repellent dielectric layer 7 can avoid deterioration with certainty.

Further, according to the present embodiment, the water-repellent dielectric layer 7 is configured such that when no voltage is applied to the first electrode 5 and the second electrode 6 from the power supply 8 the angle at which water (polar liquid) on the water-repellent dielectric layer 7 contacts the water-repellent dielectric layer 7 is within a range of 80° to 180°. Thus, according to the present embodiment, the surface energy on the water-repellent dielectric layer 7 serving as the exposed surface of the solar cell 1 is reduced, so that the adhesion of fouling onto the exposed surface can be suppressed with ease.

Further, according to the present embodiment, the angle at which the water 10 present on the water-repellent dielectric layer 7 contacts the water-repellent dielectric layer 7 is less than 80° when voltage is applied to the first electrode 5 and the second electrode 6 from the power supply 8. Thus, according to the present embodiment, the wettability of the water 10 with respect to the water-repellent dielectric layer 7 can be made adequate, so that fouling on the surface 7a can be removed with the water 10 with more certainty.

### Embodiment 2

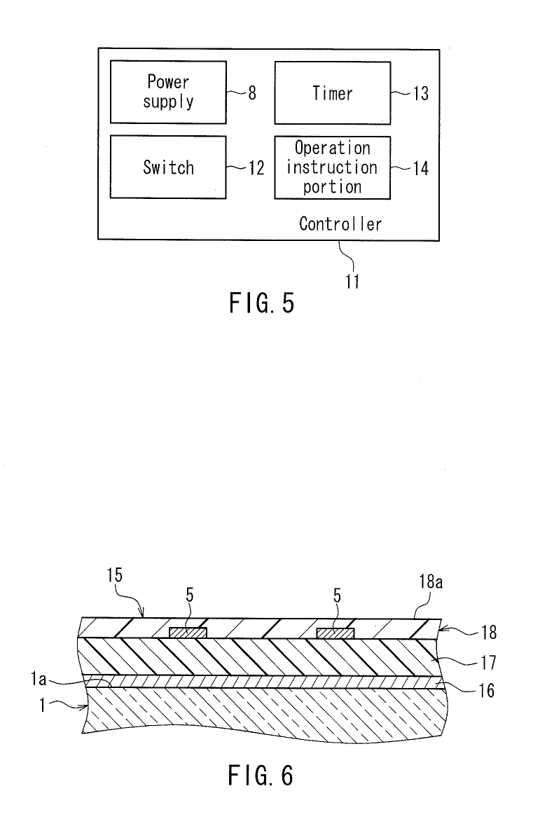

FIG. 5 is a block diagram showing the configuration of a controller for an antifouling structure according to Embodiment 2 of the present invention. In the figure, the present embodiment is mainly different from Embodiment 1 in that the present embodiment uses a controller for driving the antifouling structure, and the controller includes a timer, and voltage is applied to the first electrode and the second electrode based on timed results from the timer. Note that the same components as those of Embodiment 1 are denoted by the same reference numerals, and the explanation will not be repeated.

That is, as shown in FIG. 5, the antifouling structure of the present embodiment includes a controller 11 for driving the antifouling structure. The controller 11 includes a power supply 8, a switch 12 connected to the power supply 8, a timer 13 for measuring time, and an operation instruction portion 14 for instructing switching of the switch 12 based on timed results from the timer 13. An electric or electromagnetic switch is used as the switch 12, and it is switched between on and off in response to an instruction signal from the operation instruction portion 14. Further, the switch 12 is connected between one of the first electrode 5 and the second electrode 6, for example, the first electrode 5 and the power supply 8. And when the switch 12 is turned on, voltage is applied to the first electrode 5 and the second electrode 6 from the power supply 8.

With the above configuration, the present embodiment can have effects comparable to those of Embodiment 1. Further, according to the present embodiment, since voltage is applied to the first electrode 5 and the second electrode 6 automatically based on timed results from the timer 12 in the controller 11, fouling on the surface 7a of the water-repellent dielectric layer 7 (the surface 1a of the solar cell 1) can be removed with more certainty.

That is, when no voltage is applied, the surface 7a of the water-repellent dielectric layer 7 may be electrically charged more easily than when it is made hydrophilic, so that it tends to attract dust due to the charge. Therefore, when no voltage is applied to the first electrode 5 and the second electrode 6 for long time, the adherence of fouling occurs unnecessarily, and the fouling may not be removed only by making the surface hydrophilic. Thus, in order to avoid this with certainty, according to the antifouling structure of the present embodiment, the charge can be removed by applying voltage to the electrodes regularly based on the timer 13 to make the surface 7a as the exposed surface hydrophilic to attract moisture in air. Thus, it is possible to prevent the adhesion of dust and to remove fouling with more certainty. As the time interval during which voltage is applied based on the timer 13, the switch 12 may be operated for several hours between sunset and sunrise so that water from morning dew is used, for example.

### Embodiment 3

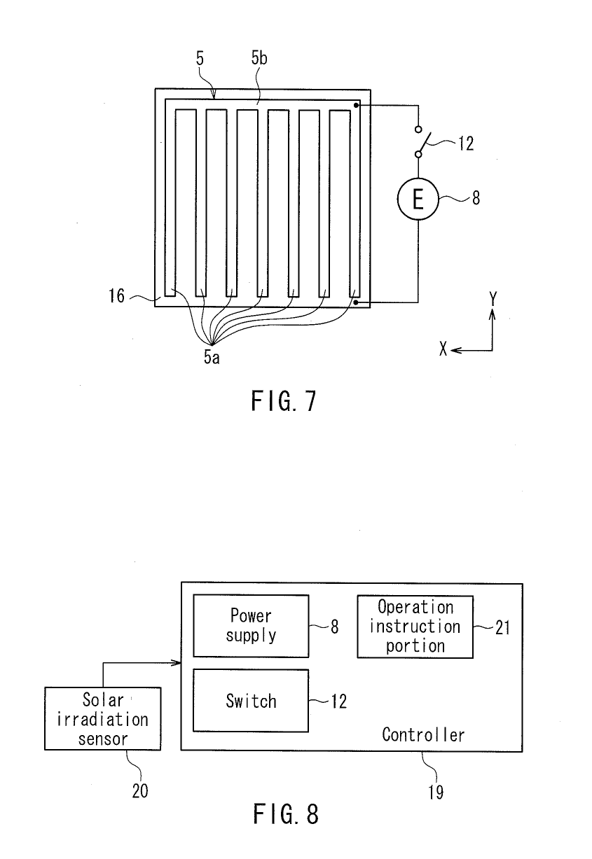

FIG. 6 is a cross-sectional view showing the main configuration of an antifouling structure according to Embodiment 3 of the present invention. FIG. 7 is a plan view for explaining a first electrode and a second electrode shown in FIG. 6. FIG. 8 is a block diagram showing the configuration of a controller for the antifouling structure shown in FIG. 6. In the figures, the present embodiment is mainly different from Embodiment 1 in that a dielectric layer having a higher dielectric constant than that of the water-repellent dielectric layer is provided on the solar cell surface side of the water-repellent dielectric layer, and voltage is applied to the first electrode and the second electrode based on detection results from a solar irradiation sensor. Note that the same components as those of Embodiment 1 are denoted by the same reference numerals, and the explanation will not be repeated.

That is, as shown in FIG. 6, according to the antifouling structure 15 of the present embodiment, a second electrode 16 having a planer shape is provided on the surface 1a of the solar cell (object) 1. The second electrode 16 is used in place of the comb-shaped electrode used in Embodiment 1, and is placed so as to cover the surface 1a entirely. Further, the antifouling structure 15 of the present embodiment includes a dielectric layer 17 that is formed so as to cover the second electrode 16, and a water-repellent dielectric layer 18 that is formed so as to cover the first electrode 5 provided on the dielectric layer 17.

A transparent dielectric film containing, for example, parilen, silicon nitride, hafnium oxide, zinc oxide, titanium dioxide, aluminum oxide or the like is used as the dielectric layer 17. Further, the dielectric film used as the dielectric layer 17 has a higher dielectric constant than that of the water-repellent dielectric layer 18, so that the effects of the electrowetting phenomenon can be readily increased when applying voltage.

Further, as in Embodiment 1, a transparent dielectric film, such as a transparent organic film, e.g., a synthetic resin such as fluororesin, or a transparent inorganic film, is used as the water-repellent dielectric layer 18, and the surface 18a of the water-repellent dielectric layer 18 serves as the exposed surface of the solar cell 1 (object) exposed to the outside.

Further, as shown in FIGS. 7 and 8, the antifouling structure 15 of the present embodiment includes a controller 19 for driving the antifouling structure 15 and a solar irradiation sensor 20. The controller 19 includes a power supply 8, a switch 12 connected to the power supply 8, and an operation instruction portion 21 for instructing switching of the switch 12 based on detection results from the solar irradiation sensor 20, and voltage is applied to the first electrode 5 and the second electrode 16 based on detection results from the solar irradiation sensor 20. That is, the controller 19 receives detection results from the solar irradiation sensor 20 as an external input instruction signal from an outside source, and the operation instruction portion 21 is configured to instruct switching of the switch 12 using the external input instruction signal.

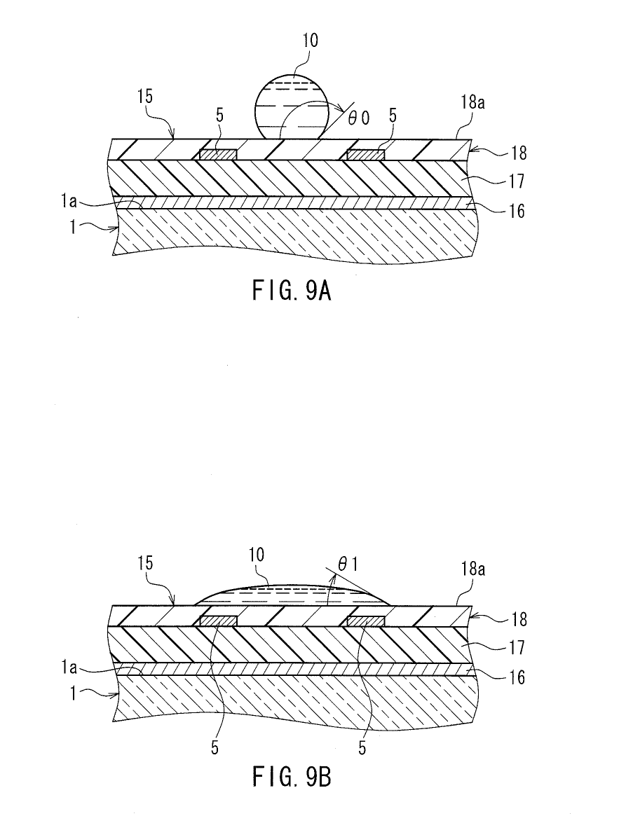

Here, the operation of the antifouling structure 15 according to the present embodiment will be described more specifically with reference to FIGS. 9A and 9B.

FIG. 9A is a diagram for explaining the condition of water present on the water-repellent dielectric layer shown in FIG. 6 when no voltage is applied to the first electrode and the second electrode shown in FIG. 6, and FIG. 9B is a diagram for explaining the condition of water present on the water-repellent dielectric layer shown in FIG. 6 when voltage is applied to the first electrode and the second electrode shown in FIG. 6.

In FIG. 9A, water 10 is adhered onto the surface 18a of the water-repellent dielectric layer 18 due to condensation or the like. Further, in FIG. 9A, the electrowetting phenomenon is not developed because no voltage is applied to the first electrode 5 and the second electrode 16. Thus, the contact angle θ0 of the water 10 with respect to the water-repellent dielectric layer 18 is within a range of 80° to 180°, preferably 90° to 180°. That is, as shown in FIG. 9A, the wettability of the water 10 with respect to the water-repellent dielectric layer 18 is small, so that the water 10 is on the surface 18a of the water-repellent dielectric layer 18 substantially in spherical shape.

Next, when voltage is applied to the first electrode 5 and the second electrode 16 of the antifouling structure 15 of the present embodiment based on detection results from the solar irradiation sensor 20, the contact angle θ1 of the water 10 with respect to the water-repellent dielectric layer 18 becomes smaller than the contact angle θ0 as shown in FIG. 9B. Specifically, the contact angle θ1 becomes less than 80°, preferably less than 60°. That is, when voltage is applied to the first electrode 5 and the second electrode 16 of the antifouling structure 15 of the present embodiment, charge is accumulated inside the water-repellent dielectric layer 18 and the dielectric layer 17, and the electrowetting phenomenon thus develops, thereby making the water-repellent dielectric layer 18 relatively hydrophilic. As a result, according to the antifouling structure 15 of the present embodiment, the wettability of the water 10 with respect to the water-repellent dielectric layer 18 increases, and the contact angle changes to θ1, the angle smaller than θ0. Thus, the water 10 spreads as shown in the figure, and fouling on the surface 18a can be removed.

With the above configuration, the present embodiment can have effects comparable to those of Embodiment 1. Further, the present embodiment uses the dielectric layer 17 having a higher dielectric constant than that of the water-repellent dielectric layer 18 and provided so as to cover the second electrode 16 on the solar cell surface side (the surface 1a side of the solar cell (object) 1) of the water-repellent dielectric layer 18. Consequently, according to the present embodiment, voltage can be applied to the water (polar liquid) 10 present on the water-repellent dielectric layer 18 more effectively, so that it is possible to cause a change (decline) in the contact angle of the water 10 due to the electrowetting phenomenon more efficiently. As a result, fouling on the surface 18a of the water-repellent dielectric layer 18 (the surface 1a of the solar cell 1) can be removed more efficiently.

Further, according to the present embodiment, voltage is applied to the first electrode 5 and the second electrode 16 based on detection results (external input instruction signal) from the solar irradiation sensor 20. Thus, the antifouling structure 15 can be operated automatically, and self cleaning effects using morning due can be readily achieved. In addition to the above description, the solar cell 1 may be used as a solar irradiation sensor by monitoring whether or not the solar cell 1 is generating power and applying voltage to the first electrode 5 and the second electrode 16 in response to the monitored results.

### Embodiment 4

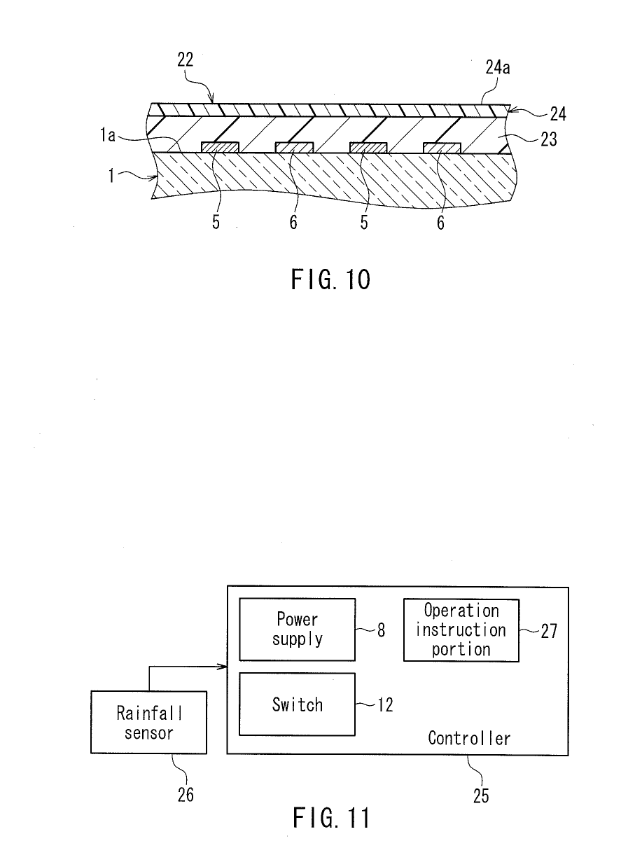

FIG. 10 is a cross-sectional view showing the main configuration of an antifouling structure according to Embodiment 4 of the present invention. FIG. 11 is a block diagram showing the configuration of a controller for the antifouling structure shown in FIG. 10. In the figures, the present embodiment is mainly different from Embodiment 1 in that a dielectric layer having a higher dielectric constant than that of the water-repellent dielectric layer is provided on the solar cell surface side of the water-repellent dielectric layer, and voltage is applied to the first electrode and the second electrode based on detection results from a rainfall sensor. Note that the same components as those of Embodiment 1 are denoted by the same reference numerals, and the explanation will not be repeated.

That is, as shown in FIG. 10, the antifouling structure 22 of the present embodiment includes on the surface 1a of the solar cell (object) 1 the first electrode 5 and the second electrode 6 using comb-shaped electrodes as in Embodiment 1. Further, the antifouling structure 22 of the present embodiment includes a dielectric layer 23 provided so as to cover the first electrode 5 and the second electrode 6, and a water-repellent dielectric layer 24 provided to cover the dielectric layer 23.

As in Embodiment 3, a transparent dielectric film containing, for example, parilen, silicon nitride, hafnium oxide, zinc oxide, titanium dioxide, aluminum oxide or the like is used as the dielectric layer 23. Further, the dielectric film used as the dielectric layer 23 has a higher dielectric constant than that of the water-repellent dielectric layer 24, so that the effects of the electrowetting phenomenon can be readily increased when applying voltage.

Further, as in Embodiment 1, a transparent dielectric film, such as a transparent organic film, e.g., a synthetic resin such as fluororesin, or a transparent inorganic film, is used as the water-repellent dielectric layer 24, and the surface 24a of the water-repellent dielectric layer 24 serves as the exposed surface of the solar cell 1 (object) exposed to the outside.

Further, as shown in FIG. 11, the antifouling structure 22 of the present embodiment includes a controller 25 for driving the antifouling structure 22 and a rainfall sensor 26. The controller 25 includes a power supply 8, a switch 12 connected to the power supply 8, and an operation instruction portion 27 for instructing switching of the switch 12 based on detection results from the rainfall sensor 26, and voltage is applied to the first electrode 5 and the second electrode 6 base on detection results from the rainfall sensor 26. That is, the controller 25 receives detection results from the rainfall sensor 26 as an external input instruction signal from an outside source, and the operation instruction portion 27 is configured to instruct switching of the switch 12 using the external input instruction signal.

With the above configuration, the present embodiment can have effects comparable to those of Embodiment 1. Further, according to the present embodiment, voltage is applied to the first electrode 5 and the second electrode 6 based on detection results (external input instruction signal) from the rainfall sensor 26. Thus, fouling on the exposed surface, i.e., the surface 24a of the water-repellent dielectric layer 24 (the surface 1a of the solar cell 1) can be removed with rainwater with more certainty at appropriate timing.

### Embodiment 5

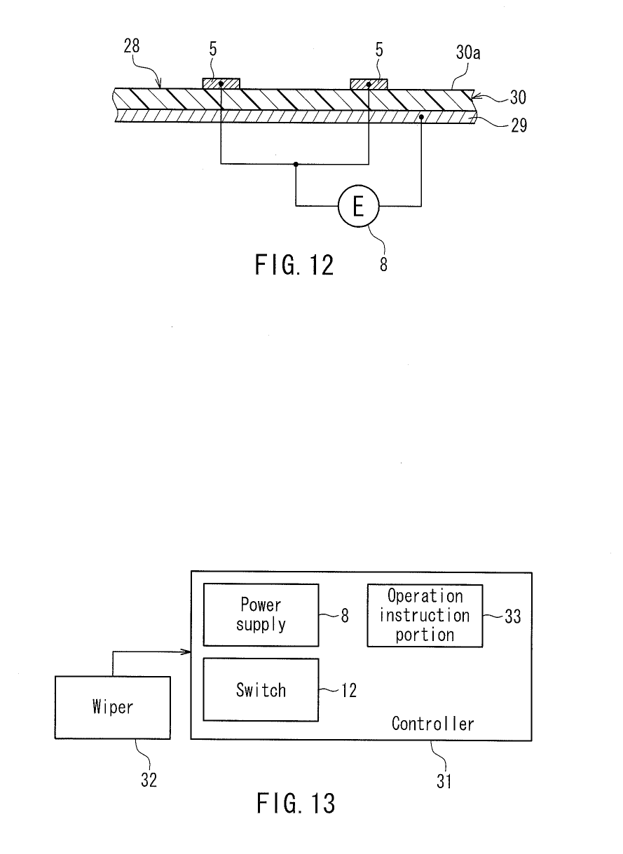

FIG. 12 is a cross-sectional view showing the main configuration of an antifouling structure according to Embodiment 5 of the present invention. FIG. 13 is a block diagram showing the configuration of a controller for the antifouling structure shown in FIG. 12. In the figures, the present embodiment is mainly different from Embodiment 1 in that an automobile is used as the object and the body of the automobile is used as the second electrode. Note that the same components as those of Embodiment 1 are denoted by the same reference numerals, and the explanation will not be repeated.

That is, in FIG. 12, an automobile is used as the object to which the antifouling structure 28 of the present embodiment is applied, and the body 29 of the automobile serves as the second electrode. Further, the antifouling structure 28 of the present embodiment includes a water-repellent dielectric layer 30 provided so as to cover the body 29 and the first electrode 5 formed on the water-repellent dielectric layer 30. As in Embodiment 1, a transparent dielectric film, such as a transparent organic film, e.g., a synthetic resin such as fluororesin, or a transparent inorganic film, is used as the water-repellent dielectric layer 30, and the surface 30a of the water-repellent dielectric layer 30 serves as the exposed surface of the automobile (object) exposed to the outside.

Further, as shown in FIG. 13, the antifouling structure 28 of the present embodiment includes a controller 31 for driving the antifouling structure 28, and a wiper 32 of the automobile is connected to the controller 31. Further, the controller 31 includes a power supply 8, a switch 12 connected to the power supply 8, and an operation instruction portion 33 for instructing switching of the switch 12 in response to the operation of the wiper 32, and voltage is applied to the first electrode 5 and the body 29 as the second electrode when the wiper 29 is operated. That is, the controller 31 receives an operation signal from the wiper 32 as an external input instruction signal from an outside source, and the operation instruction portion 33 is configured to instruct switching of the switch 12 using the external input instruction signal.

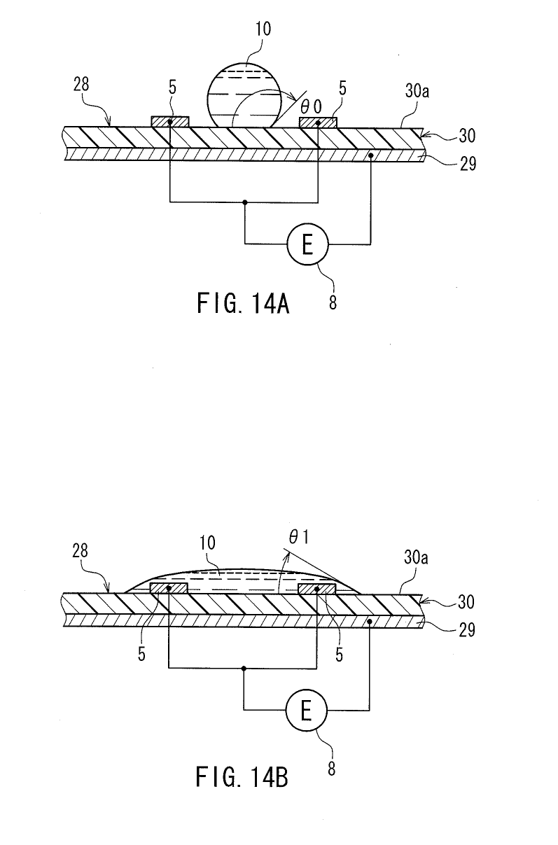

Here, the operation of the antifouling structure 28 of the present embodiment will be described more specifically with reference to FIGS. 14A and 14B.

FIG. 14A is a diagram for explaining the condition of water present on the water-repellent dielectric layer shown in FIG. 12 when no voltage is applied to the first electrode and the second electrode shown in FIG. 12, and FIG. 4B is a diagram for explaining the condition of water present on the water-repellent dielectric layer shown in FIG. 12 when voltage is applied to the first electrode and the second electrode shown in FIG. 12.

In FIG. 14A, water 10 is adhered onto the surface 30a of the water-repellent dielectric layer 30 due to rainfall, or the like. Further, in FIG. 14A, the electrowetting phenomenon is not developed because no voltage is applied to the first electrode 5 and the body 29. Thus, the contact angle θ0 of the water 10 with respect to the water-repellent dielectric layer 30 is within a range of 80° to 180°, preferably 90° to 180°. That is, as shown in FIG. 14A, the wettability of the water 10 with respect to the water-repellent dielectric layer 30 is small, so that the water 10 is on the surface 18a of the water-repellent dielectric layer 18 substantially in spherical shape as shown in the figure.

Next, when voltage is applied to the first electrode 5 and the body 29 of the antifouling structure 28 of the present embodiment in response to the operation of the wiper 32, the contact angle θ1 of the water 10 with respect to the water-repellent dielectric layer 30 becomes smaller than the contact angle θ0 as shown in FIG. 14B. Specifically, the contact angle θ1 becomes less than 80°, preferably less than 600. That is, when voltage is applied to the first electrode 5 and the body 29 of the antifouling structure 28 of the present embodiment, charge is accumulated inside the water-repellent dielectric layer 30, and the electrowetting phenomenon thus develops, thereby making the water-repellent dielectric layer 30 relatively hydrophilic. As a result, according to the antifouling structure 28 of the present embodiment, the wettability of the water 10 with respect to the water-repellent dielectric layer 30 increases, and the contact angle changes to θ1, the angle smaller than θ0. Thus, the water 10 spreads as shown in the figure, and fouling on the surface 30a can be removed.

With the above configuration, the present embodiment can have effects comparable to those of Embodiment 1. Further, according to the present embodiment, the body (metal) 29 provided on the surface side of the automobile (object) is used as the second electrode. Thus, according to the present embodiment, not only that the antifouling structure 28 can readily be applied to a preinstalled object, but also that the antifouling structure 28 having a simple structure can be formed using a small number of items with ease.

Further, according to the present embodiment, voltage is applied to the first electrode 5 and the body 29 in response to the operation of the wiper 32 (external input instruction signal). That is, according to the present embodiment, the controller 31 automatically determines whether it is raining or not based on the operation of the wiper 32, so that fouling on the exposed surface, i.e., the surface 30a of the water-repellent dielectric layer 30 (the body 29 of the automobile) can be washed off with certainty with the water 10 from the rainfall.

In addition to the above description, the coating layer of the automobile formed on top of the body 29 (second electrode) of the automobile can be used as the water-repellent dielectric layer 30.

The embodiments described above are to be considered in all respects as illustrative and not limiting. The technical scope of the invention is indicated by the appended claims rather than by the foregoing description, and all changes which come within the meaning and range of equivalency of the claims are intended to be embraced therein.

For example, in the above description, the present invention has been applied to a solar cell or the body of an automobile (vehicle) but the objects to which the antifouling structure of the present invention can be applied are not limited to these. The antifouling structure of the present invention can be applied to constructions with which the first electrode and the second electrode and the water-repellent dielectric layer can be provided and water (polar liquid) can be present on the water-repellent dielectric layer. Specific examples of objects to which the antifouling structure of the present invention can be applied include the following: windows or wall surfaces of buildings such as houses and hard-to-maintain high rise buildings; surfaces of outdoor electric equipment such as outdoor displays and outdoor lighting equipment that are required to be maintenance-free; glass windows of moving objects such as vehicles; and surfaces of outer walls.

Further, in the above description, (rain) water has been used as the polar liquid. However, the polar liquid of the present invention is not limited to water, and specific examples of usable liquids include those containing electrolytes such as potassium chloride, zinc chloride, potassium hydroxide, sodium hydroxide, alkali metal hydroxide, zinc oxide, sodium chloride, lithium salts, phosphoric acids, alkali metal carbonates, ceramics having oxygen ion conductivity. Further, in addition to water, examples of usable solvents include organic solvents such as alcohol, acetone, formamide, and ethylene glycol. Further, ionic liquids (ambient temperature molten salts) including cations such as pyridine cations, alicyclic amine cations, and fatty amine cations, and anions such as fluorine anions such as fluoride ion and triflate. Further, examples of the polar liquid of the present invention also include conductive liquids having conductivity, and highly dielectric liquids having a certain relative dielectric constant, preferably a relative dielectric constant of 15 or more.

In the above description, condensed water and water (rain) naturally fallen on the water-repellent dielectric layer serving as the exposed surface of the object have been used. However, the antifouling structure of the present invention is not limited to such configurations. For example, the antifouling structure may include a sprinkler, and water artificially sprinkled onto the water-repellent dielectric layer can be used.

In the above description, transparent conductive films have been used as the first electrode and the second electrode, and transparent dielectric films have been used as the water-repellent dielectric layer and the dielectric layer. The present invention is not limited to such configurations and changes can be made as appropriate in accordance with the use of objects or the like. That is, nontransparent metal such as copper, silver or the like may be used for the first electrode and the second electrode, and light-shielding dielectric films may be used as the water-repellent dielectric layer and the dielectric layer.

Further, in Embodiments 3 to 5, detection results from the solar irradiation sensor, detection results from the rainfall sensor, and the operation of a wiper were used as external input instruction signals. However, external input instruction signals are not limited to the above as long as the operation instruction portion instructs switching of the switch using an external input instruction signal from an external apparatus or device such as an external sensor.

In addition to the above description, Embodiments may be combined with each other as appropriate. Specifically, Embodiments 2 and 3 may be combined with each other. Such a configuration is preferred because the antifouling structure can be operated automatically using timed results from the timer and detection results from the solar irradiation sensor, allowing removal of fouling on the surface of the object with more certainty at more appropriate timing.

### INDUSTRIAL APPLICABILITY

The present invention is useful as an antifouling structure whose capability of preventing fouling of a surface of an object can avoid deterioration and an operation method of the antifouling structure.

### DESCRIPTION OF REFERENCE NUMERALS

1 solar cell (object)
1a surface
4, 15, 22, 28 antifouling structure
5 first electrode
5a electrode portion
6, 16 second electrode
6a electrode portion
7, 18, 24, 30 water-repellent dielectric layer
8 power supply
10 water (polar liquid)
12 switch
13 timer
14, 21, 27, 33 operation instruction portion
17, 23 dielectric layer
29 body (second electrode) of (automobile (object))
θ0, θ1 contact angle

1: An antifouling structure for removing fouling on a surface of an object, comprising:
a first electrode and a second electrode provided on the surface of the object;
a power supply for applying voltage to the first electrode and the second electrode; and
a water-repellent dielectric layer provided so as to cover at least one of the first electrode and the second electrode,
wherein voltage is applied to the first electrode and the second electrode from the power supply such that an angle at which a polar liquid present on the water-repellent dielectric layer contacts the water-repellent dielectric layer decreases.

2: The antifouling structure according to claim 1, wherein a comb-shaped electrode having a plurality of electrode portions arranged in parallel to each other is used as at least one of the first electrode and the second electrode.

3: The antifouling structure according to claim 1, wherein metal provided on the object surface side is used as one of the first electrode and the second electrode.

4: The antifouling structure according to claim 1, further comprising a dielectric layer having a higher dielectric constant than that of the water-repellent dielectric layer, the dielectric layer being provided so as to cover at least one of the first electrode and the second electrode on the object surface side of the water-repellent dielectric layer.

5: The antifouling structure according to claim 1, wherein the water-repellent dielectric layer is configured such that when no voltage is applied to the first electrode and the second electrode from the power supply, the angle at which the polar liquid present on the water-repellent dielectric layer contacts the water-repellent dielectric layer is within a range of 80° to 180°.

6: The antifouling structure according to claim 1, wherein when voltage is applied to the first electrode and the second electrode from the power supply, the angle at which the polar liquid present on the water-repellent dielectric layer contacts the water-repellent dielectric layer is less than 80.

7: The antifouling structure according to claim 1, further comprising:
a switch connected between the power supply and one of the first electrode and the second electrode;
a timer for measuring time; and
an operation instruction portion for instructing switching of the switch,
wherein the operation instruction portion instructs switching of the switch based on timed results from the timer.

8: The antifouling structure according to claim 1, further comprising:
a switch connected between the power supply and one of the first electrode and the second electrode; and
an operation instruction portion for instructing switching of the switch,
wherein the operating instruction portion instructs switching of the switch using an external input instruction signal from an outside source.

9: The antifouling structure according to claim 8, further comprising a timer for measuring time,
wherein the operation instruction portion instructs the switch to be switched based on timed results from the timer.

10: A method of operating an antifouling structure for removing fouling on a surface of an object, the antifouling structure comprising a first electrode and a second electrode provided on the surface of the object and a water-repellent dielectric layer provided so as to cover at least one of the first electrode and the second electrode,
the method comprising the steps of:
applying voltage to the first electrode and the second electrode such that an angle at which a polar liquid present on the water-repellent dielectric layer contacts the water-repellent dielectric layer decreases; and
removing fouling on the object with the polar liquid.
